(19) United States
(12) Patent Application Publication
(10) Pub. No.: US 2010/0155513 A1
(43) Pub. Date: Jun. 24, 2010

(54) BALE BREAKER APPARATUS AND METHOD

(75) Inventors: Jamey Brick, Paynesville, MN (US); Patrick Burg, Richmond, MN (US); Nicholas Lieser, Lake Henry, MN (US)

Correspondence Address: Altera Law Group, LLC, 220 S 6 St Suite 1700, Minneapolis, MN, 55402, US

(73) Assignee: Rotochopper, Inc., St. Martin, MN (US)

(21) Appl. No.: 12/641,855

(22) Filed: Dec. 18, 2009

Related U.S. Application Data
(60) Provisional application No. 61/139,122, filed on Dec. 19, 2008.

(51) Int. Cl. B02C 23/02; B02C 25/00

(52) U.S. Cl. 241/30; 241/186.4; 241/186.3; 241/101.4

(57) ABSTRACT

An auxiliary powerfeed is disclosed, which is designed to work in conjunction with other feeding devices found on a horizontal grinder, which typically include a horizontal feed conveyor and a powerfeed drum. The auxiliary powerfeed features a rotating drum on which are mounted rigid tines (or teeth) arranged in a staggered pattern. The drum is rotationally mounted within a pivotally mounted lift arm. The lift arm holds the axial shaft of the drum at each end. A set of hydraulic cylinders is mounted to the lift arm, one on each end of the drum. During operation, as a bale or other object comes into contact with the auxiliary powerfeed, the drum automatically lifts until it reaches the top of the object, the limit of its lift path, or a predetermined height that optimizes efficacy for a particular application. In some cases, the auxiliary powerfeed automatically operates differently with different feedstock consistencies. In other cases, the auxiliary powerfeed is set to operate on a predetermined sequence based on feedstock consistency.

### CROSS-REFERENCE TO RELATED APPLICATIONS

The present application claims priority under 35 U.S.C §119(e) to provisional application No. 61/139,122, filed on Dec. 19, 2008 under the same title. Full Paris Convention priority is hereby expressly reserved.

### STATEMENT REGARDING FEDERALLY SPONSORED RESEARCH OR DEVELOPMENT

Not Applicable

### BACKGROUND OF THE INVENTION

1. Field of the Invention

The present invention is directed to an auxiliary powerfeed and its control system, designed to assist a horizontal grinder that processes materials that are bound, packaged, or otherwise joined together into solid form, such as round and square agricultural bales.

2. Description of the Related Art

Baling of products is common across a wide range of industries because many bulk products are easier to handle and take up less space in a compacted bale form. Common baled materials include agricultural products like hay, straw, and corn stover, as well as waste and recyclable materials. For instance, cardboard and paper may be shipped to recycling or disposal facilities in baled form for ease of transport and handling. Yet such products are rarely utilized in baled form.

Farmers often process bales with tub grinders or other equipment to produce a consistent particle size that optimizes value. When used for animal feed, baled feed material is often ground up to increase its digestibility and acceptance by the animals consuming it. Once ground up, it can also be mixed with other feed materials to produce a nutritionally balanced food with optimal portions of fiber, minerals, and so on. Grinding bales also reduces waste and allows more even distribution to all animals. When bales are set in a cattle pasture, for instance, much of the material ends up trampled into the ground as cows fight for access to the bales. More dominant livestock often eat more while weaker livestock may become undernourished. Bale grinding allows farmers to distribute the feed material in windrows in a pasture or in troughs or bunkers using augers, belt conveyors, or similar equipment, giving each animal equal access.

Agricultural products like corn stover, switchgrass, and miscanthus are rapidly gaining popularity as bioenergy sources. These types of plants grow more quickly than trees and can be conveniently transported in baled form. Plant fiber used for bioenergy conversion may be grown specifically for that purpose, or it may be the residue remaining after the grains, fruits, or vegetables have been harvested. Corn stover, for instance, includes the stalks, leaves, and husks that remain after the seeds have been harvested. In most cases, plant fibers used in biomass energy conversion need to refined into uniform particle sizes to be used.

Bales are bound with organic or plastic twine, wire, plastic mesh, cellophane wrap, and many other similar materials. In the case of organic materials like hay, bales may remain in their original forms even after the binding is removed or broken, rather than simply crumbling apart. Certain types of grinding equipment may therefore require feeding components to break apart compacted bales into manageable flows of loose particles to their grinding rotors. Grinding machines known commercially as horizontal grinders often have feed openings that are too small to effectively or efficiently process round bales.

A standard powerfeed drum, also called a pre-crusher or feed roller, is designed to apply downward pressure and rotate at a controlled rate, thereby providing a measure of control over the rate at which feedstock enters the grinding chamber. With some feedstocks, such as wooden crates, the powerfeed's rotation and downward pressure may also advantageously separate portions from the whole and/or crush the incoming objects, allowing them to be fed to the rotor more evenly and allowing the rotor to more efficiently grind them, since the powerfeed can more effectively stabilize them. If a wooden crate having vertical and horizontal members reaches the rotor, the rotor's teeth may rip individual boards from the crate upon contact, pulling them into the grinding chamber in largely whole form. If these boards are dissembled from the whole prior to contacting the rotor, the powerfeed can more effectively grip them as the rotor strikes them, allowing a more controlled processing rate. Yet a standard powerfeed often cannot effectively separate portions from the whole of a bale, crate, or other feedstock described above and still provide the downward pressure necessary to stabilize the separated material.

Round bales are typically tightly compacted and too large to be fed efficiently into a horizontal grinder or, in some cases, to be fed at all. Tub grinders, having a much larger feed opening, are the most common choice for grinding round bales. Most often, the rotor in a tub grinder is directly exposed at the bottom of the tub. The rotation of the rotor therefore is what separates material away from the solid bale, in addition to grinding the loose material. In some cases, tub grinders also have some type of bale breaker to preprocess the baled material and feed it to the rotor. Yet, even if a tub grinder has a bale breaker device, it still has several limitations that become evident when compared to a horizontal grinder.

For example, a tub grinder is typically limited to processing one round bale at a time, whereas the infeed conveyor of a horizontal grinder can accept multiple bales or be coordinated with another bale handling conveyor, allowing bales to be fed without interruption. With a horizontal grinder, separated, loose material rests on the infeed conveyor, which moves it toward the rotor at a controlled speed, whereas loose material may be immediately and completely pushed into the rotor in a tub grinder.

Because tub grinders are most often fed from the top, the weight of individual bales can affect processing efficiency and efficacy. Light, loose material has a tendency to float above the rotor, while dense, heavy material may press down upon the rotor, decreasing efficiency. In some cases, the rotor in a tub grinder may pull material into the grinding chamber too quickly, creating excessive rotor drag, or in more extreme cases, stalling the rotor. Even if a tub grinder has a preprocessing device, its efficiency and efficacy may also be affected by the weight of the feed material. The processing rate may change as the bale is being ground up and it becomes lighter. Tub grinders often experience fluctuations in horsepower efficiency and production rates for these reasons.

Typically, tub grinders feature rotating tubs, which are generally funneled. The rotation of the tub forces the raw material into the rotor or preprocessing device. Tub rotation and gravity alone determine the rate at which raw material comes into contact with the preprocessing device or rotor. Speed of tub rotation is typically determined by available horsepower, raw material consistency, reduction ratio (i.e., size of raw material in comparison to size of desired end product), type of rotor and rotor teeth, and other factors that affect processing rates. On many tub grinders, tub rotation speed is regulated according to engine or electric motor load. On a tub grinder with load regulation, as the load on the engine or electric motor increases, the tub will slow down and/or stop in attempt to lower the load on the rotor. Even when the tub stops altogether, however, gravity is still forcing the bale down into the rotor.

Horizontal grinders are certainly not immune to the problems that affect the performances of tub grinders, yet these problems are more manageable in horizontal grinders. The nature of horizontal grinders allows equipment designers to develop more effective solutions to these problems.

Horizontal grinders allow for more controlled feed rates because the feedstock is delivered to the rotor by a horizontal conveyor. Typically, a horizontal grinder also features a device commonly referred to as a powerfeed wheel, powerfeed drum, feed wheel, feed roller, or other similar names. Generally a powerfeed includes a rotating drum located above the infeed conveyor just prior to the rotor. Typically, a powerfeed drum lifts automatically to accommodate the height of oncoming raw material. Powerfeed drums usually feature serrated plates or cleats to provide traction and control delivery of feedstock to the rotor.

If the powerfeed drum is capable of lifting high enough to feed a round bale (or other feedstock mentioned previously), however, a large portion of the rotor is then exposed to the oncoming bale, allowing the rotor to draw too much raw material into the grinding chamber, resulting in decreased efficiency or perhaps plugging. If the powerfeed drum is incapable of lifting high enough to gain traction on a round bale, it will not be able to feed the bale to the rotor. In most cases, the cleats or serrated teeth on a powerfeed are incapable to tearing material away from the bale at a controlled rate because the bale may roll backward. Also, if the cleats/teeth on a powerfeed were long enough to tear material from a bale, they would be ineffective for feedstocks like logs, pallets, and slabs.

There exists a need for a device that can tear material away from the bale so that the loose material can be delivered to grinding devices at a controlled rate. By separating these materials before they reach the standard powerfeed, the efficiency and efficacy of the standard powerfeed and the grinder as a whole may be improved, thereby optimizing the effectiveness of its downward pressure and rate of rotation.

### BRIEF SUMMARY OF THE INVENTION

An embodiment is an auxiliary powerfeed attachable to a frame of a fragmentation machine, comprising: a pivotable arm attached to the frame at a hinge; a rotatable drum disposed at an end of the pivotable arm away from the hinge, the drum being rotatable in a forward direction complementary to a direction of a generally horizontal conveyor that feeds material into the fragmentation machine, the drum also being rotatable in a reverse direction opposing the direction of the conveyor; and a plurality of angled teeth on the drum, the teeth being configured to cut the material when the drum is rotated in the forward direction and configured to push the material when the drum is rotated in the reverse direction.

Another embodiment is a subsystem of a fragmentation machine, comprising: a generally horizontal conveyor for feeding round bales into the fragmentation machine along a conveyor direction; a rotatable drum disposed above the conveyor, the drum having a generally horizontal rotational axis generally perpendicular to the conveyor direction, the drum being rotatable in a forward direction complementary to the conveyor direction, the drum also being rotatable in a reverse direction opposing the conveyor direction; and a plurality of angled teeth on the drum, the teeth being angled to tear material from the round bales when the drum is rotated in the forward direction and angled to unroll the round bales along the conveyor when the drum is rotated in the reverse direction.

A further embodiment is a method for controlling an auxiliary powerfeed for a fragmentation machine, comprising: running a generally horizontal conveyor; rotating with a hydraulic drum motor a drum having angled teeth in a forward direction complementary to the conveyor direction, the teeth being angled to cut material on the conveyor when the drum is rotated in the forward direction; detecting a pressure from the hydraulic drum motor; comparing the detected pressure with a predetermined pressure threshold; determining that the detected pressure exceeds the predetermined pressure threshold; and rotating with the hydraulic drum motor the drum in a reverse direction opposing the conveyor direction, the teeth being angled to push the material on the conveyor when the drum is rotated in the reverse direction.

### BRIEF DESCRIPTION OF THE SEVERAL VIEWS OF THE DRAWINGS

FIG. 1 is a cross-sectional drawing of a fragmenting machine.

FIG. 2 is a cross-sectional drawing of a fragmenting machine.

FIG. 3 is a cross-sectional drawing of a fragmenting machine.

FIG. 4 is a cross-sectional drawing of fragmenting machine having an auxiliary powerfeed.

FIG. 5 is a cross-sectional drawing of fragmenting machine having an auxiliary powerfeed.

FIG. 6 is a cross-sectional drawing of fragmenting machine having an auxiliary powerfeed.

FIG. 7 is a cross-sectional drawing of fragmenting machine having an auxiliary powerfeed.

FIG. 8 is a flow chart showing how the system detects an object on the conveyor that is too large, dense, or hard to pass through to the regular powerfeed.

FIG. 9 is a flow chart showing that for a particularly troublesome bale, where a short reverse run of the drum is inadequate, the drum may be run in reverse for an extended time interval.

FIG. 10 includes various flow charts that show when to employ an extended reverse run of the drum.

FIG. 11 is a cross-sectional drawing of a drum showing one tooth.

FIG. 12 is a cross-sectional drawing of a drum showing one tooth.

FIG. 13 is a cross-sectional drawing of a drum showing one tooth.

### DETAILED DESCRIPTION OF THE INVENTION

An auxiliary powerfeed is designed to assist a horizontal grinder to process materials that are bound, packaged, or otherwise joined together into solid form, including round and square agricultural bales, baled recyclables (such as plastic bottles), and gaylord boxes. Other feedstocks for which it may provide advantages include cabinets, crates, and other objects constructed by nailing or otherwise joining individual members of wood, plastic, or other light materials. The purpose of the auxiliary powerfeed is to separate these materials before they reach the standard powerfeed, thereby increasing the efficiency and efficacy of the standard powerfeed and the grinder as a whole.

An auxiliary powerfeed is disclosed, which is designed to work in conjunction with other feeding devices found on a horizontal grinder, which typically include a horizontal feed conveyor and a powerfeed drum. The auxiliary powerfeed features a rotating drum on which are mounted rigid tines (or teeth) arranged in a staggered pattern. The drum is rotationally mounted within a pivotally mounted lift arm. The lift arm holds the axial shaft of the drum at each end. A set of hydraulic cylinders is mounted to the lift arm, one on each end of the drum. During operation, as a bale or other object comes into contact with the bale breaker, the drum automatically lifts until it reaches the top of the object, the limit of its lift path, or a predetermined height that optimizes efficacy for a particular application. In some cases, the auxiliary powerfeed automatically operates differently with different feedstock consistencies. In other cases, the auxiliary powerfeed is set to operate on a predetermined sequence based on feedstock consistency.

The preceding paragraphs are merely a summary for this disclosure, and should not be construed as limiting in any way.

Note that the auxiliary powerfeed may alternatively be referred to as a bale breaker, a hay buster, a bale buster, or a hay ripper; it is understood that the auxiliary powerfeed has applications beyond that of processing bales.

Note also that the term “generally horizontal”, as used in this document, is intended to mean horizontal, or within reasonable tolerances for horizontal. For instance, an object placed on a generally horizontal conveyor will stay on the conveyor under the influence of gravity and friction, and will not slide off the conveyor. A generally horizontal conveyor may be moveable on a wheeled vehicle, and may be parked on a slight incline. In general, the slight incline of the terrain does not affect the horizontality of the conveyor.

The advantages of the auxiliary powerfeed apply to a wide range of feedstocks, as described above, although its function may be best understood in relation to bales. In many cases, where a bale is used to describe certain advantages, these advantages may also be applied to other feedstocks.

Although the auxiliary powerfeed may decrease horsepower available to other components, its benefits of efficiency and efficacy significantly outweigh this drawback.

As a first advantage, the auxiliary powerfeed eliminates need for the powerfeed to lift to the top of a bale, crate, or other applicable feedstock to feed it. As the powerfeed drum rises, more of the rotor becomes exposed, allowing the rotor to draw more feedstock into the grinding chamber, affecting efficiency.

As a second advantage, by preprocessing a bale into a flow of loose material before it reaches the powerfeed, the powerfeed drum can serve its initial design purpose: to provide control over the feedstock as it comes into contact with the rotor by applying downward pressure. If the powerfeed drum has to lift to the top of the bale, it cannot perform this function as effectively. For instance, if the powerfeed drum has to lift to feed a large diameter log to the rotor, the downward pressure it applies will stabilize the whole log (to a reasonable degree), allowing the rotor to break pieces from the log at a controlled rate. However, downward pressure applied to a bale of hay will not stabilize the whole bale because a bale does not have the same rigidity.

As a third advantage, by separating baled material into a flow of loose material with the auxiliary powerfeed and controlling the flow of this material with the infeed conveyor and regular powerfeed, the rotor is only responsible for grinding the material into a finished product, which means almost all of the rotor's force is directly translated into grinding. Since the rotor does not have to tear material from the bale, it can stay at peak speed and torque.

As a fourth advantage, fitting a horizontal grinder with an auxiliary powerfeed can eliminate need for additional equipment (such as a feeding conveyor with a bale breaker) to perform this task, which is especially convenient for mobile horizontal grinders. By fitting a bale breaker to the grinder, rather than a separate machine, the bale breaker can be effectively controlled by the same control system that operates the grinder. If the grinder's diesel engine or electric motor comes under an excessive load, the auxiliary powerfeed can be slowed down or stopped along with the rest of the feed system.

As a fifth advantage, an auxiliary powerfeed can allow a horizontal grinder that lacks a suitable powerfeed lift height to process round bales.

It is instructive to first describe a horizontal grinder in its general sense. An exemplary description is provided in U.S. Pat. No. 7,611,085, titled “Device and method for improving power feed efficacy for comminuting machines”, issued on Nov. 3, 2009 to Murray McIntyre and Jamey Brick. Excerpts from this exemplary description are provided below.

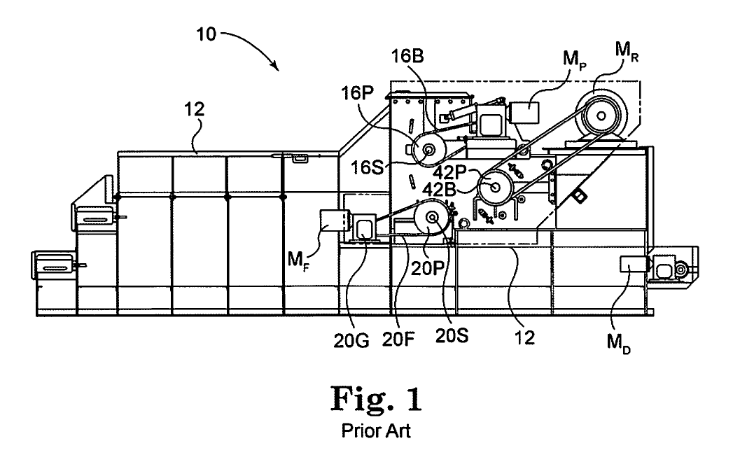

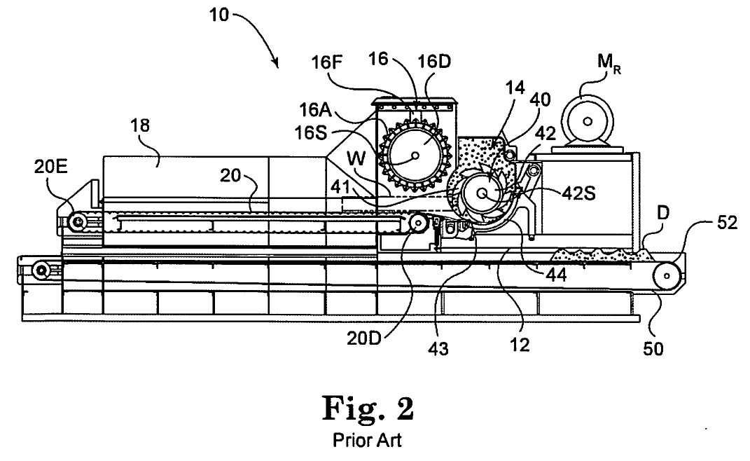

FIGS. 1 and 2 provide complementary cross-sectional views of one embodiment of a known waste fragmenting machine 10, also referred to as a horizontal grinder. The machine 10 is designed to splinter and/or fragment wastes under tremendous impacting forces. Such machine may include a frame 12 structurally sufficient to withstand the vigorous mechanical workings of machine 10.

In the design of FIGS. 1 and 2, the machine 10 is powered by several electrical motors generally prefixed by M, namely M_{R}, M_{D}, M_{P}, and M_{F}. These electric motors are illustrated as equipped with suitable drive means for powering the various working components, namely the feeding, fragmenting and discharging means of machine 10. It will be obvious to one skilled in the art that the machine 10 may alternatively be powered by a variety of different power sources, such as internal combustion engines, diesel engines, hydraulic motors, industrial and tractor driven power take-off, and so forth.

In the design of FIGS. 1 and 2, during basic operational use, waste materials W are power fed by a conveyer system to a fragmenting or grinding chamber 14 by a powered feed system 16 powered by a feed motor M_{F} in cooperative association with a power feed rotor drum 16D powered by power feed motor M_{P}.

For the design of FIGS. 1 and 2, the machine 10 includes a hopper 18 for receiving waste materials W and a continuously moving infeed conveyer 20 for feeding wastes W to the waste fragmenting or grinding chamber 14. An infeed conveyer 20 may be suitably constructed of rigid apron sections hinged together and continuously driven about drive pulley 20D and an idler pulley 20E disposed at an opposing end of the conveyer 20. The conveyer 20 may be operated at an apron speed of about 10 feet per minute (5 cm per second) to about 30 feet per minute (15 cm per second), depending upon the type of waste material W. The travel rate or speed of infeed conveyer 20 may be appropriately regulated through control of gearbox 20G. Feed motor M_{F}, in cooperative association with gear box 20G, apron drive pulley 20P, chain 20F, and apron drive sprocket 20D driven about feed shaft 20S, serves to drive continuous infeed conveyer 20 about feed drive pulley 20D and idler pulley 20E.

Power feed system 16 is driven by motor M_{P} and in cooperative association with the infeed conveyer 20, driven by motor M_{F}, uniformly feeds and distributes bulk wastes W, such as cellulose-based materials, to the fragmenting or grinding chamber 14. Power feed system 16 positions and aligns the waste W for effective fragmentation by the fragmenting rotor 40.

In the design of FIGS. 1 and 2, the power feed system 16 includes a power feed wheel or rotor drum 16D equipped with projecting feeding teeth 16A positioned for counterclockwise rotational movement about power feed wheel 16D. Power feed wheel 16D may be driven by power feed shaft 16S, which in turn is driven by chain 16B, drive sprocket 16P and motor M_{P}. The design of FIGS. 1 and 2 also includes arm 16F, which holds power feed wheel 16D in position. The illustrated design may allow rotation and lifting of power feed wheel 16D with undesirable ever-increasing distance between power feed wheel 16D and fragmenting rotor 40, and waste W, as the wheel 16D is rotated and lifted.

A rotary motor M_{R} serves as a power source for powering a fragmenting rotor 40 that operates within the fragmenting or grinding chamber 14. The fragmenting and grinding are accomplished, in part, by shearing or breaking teeth 41 which rotate about a cylindrical drum 42 and exert a force downwardly and radially outward, pulling and shearing action upon the waste material W as it is fed onto a striking bar 43 and sheared thereupon by the teeth 41. The shearing teeth 41 project generally outwardly from the cylindrical drum 42, which is typically rotated at an operational speed of about 1800 revolutions per minute to about 2500 revolutions per minute, although other rotational speeds may also be used.

The fragmenting rotor 40 is driven about a power shaft 42S, which is in turn powered by a suitable power source such as motor M_{R}. Motor M_{R} is drivingly connected to power shaft pulley 42P which drivingly rotates power shaft 42S within power shaft bearing 42B. The rotating teeth 41 thus create a turbulent flow of the fragmenting wastes W within the fragmenting chamber 14.

In some cases, initial fragmentation of the waste feed W occurs within the dynamics of a fragmenting or grinding chamber 14. For the design of FIGS. 1 and 2, the fragmenting chamber 14 includes a striking bar 43 and a cylindrical drum 42 equipped with a dynamically balanced arrangement of the shearing or breaker teeth 41. The striking bar 43 serves as a supportive anvil for shearing waste material W fed to the fragmenting zone. Teeth 41 are staggered upon cylindrical drum 42 to dynamically balance rotor 40.

Rotor 40, typically rotated at an operational speed of about 1800 revolutions per minute to about 2500 revolutions per minute, rotates about shaft 42S. Material fragmented by the impacting teeth 41 is then radially propelled along the curvature of the screen 44. Screen 44, in cooperation with the impacting teeth 41, refines the waste W into a desired particle size until ultimately fragmented to a sufficient particle size so as to pass through screen 44 for collection and discharge by discharging conveyor 50. A discharging motor M_{D} serves as a power source for powering a discharging means 52, illustrated as a conveyor belt and pulley system, wherein the discharging means 52 conveys processed products D from the machine 10.

In the design of FIGS. 1 and 2, the power feed system 16 helps maintain a consistent feed rate to the fragmenting chamber 14 and the rotor 40. Stabilization of the feed material prior to entry into the fragmenting chamber is essential to fragmentation speed and efficiency. The need for feed stability in a fragmenting machine is relative to the size and consistency of the feed material, as well as the rotor rotational speed and torque. Thus, the power feed system 16, also referred to interchangeably in the art as a pre-crusher, power feeder, power feed drum, power feed roll or roller, or powerfeed, is an integral component of an efficient horizontal grinder.

A typical power feed wheel 16D usually includes serrated plates, cleats or other elements, represented in FIG. 2 as teeth 16A, that grip the feed material as it is delivered to the fragmenting chamber 14 and the rotor 40.

The power feed wheel 16D maintains a particular downward pressure on the feed material, which in turns helps regulate the speed at which the material enters the fragmenting chamber 14 and encounters the rotor 40. This downward pressure helps prevent the fragmenting rotor 40 from pulling the feed material in too quickly. The downward pressure of the power feed wheel 16D stabilizes the feed material by providing a level of compression and lateral movement of the feed material prior to encountering the rotor 40, thus improving the efficacy of fragmentation within the fragmenting chamber 14.

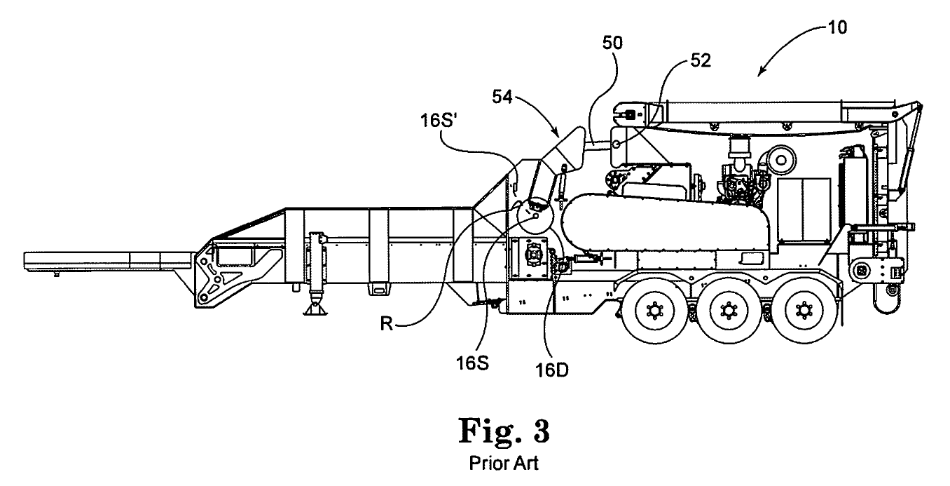

The power feed wheels 16D may be fixed in operational position relative to the feed material by one or more arms 16F, as shown in FIGS. 1 and 2. Alternatively, as shown in FIG. 3, the power feed wheels 16D may be pivotally mounted on at least one arm 16F, preferably two arms 16F, which allow the power feed wheel 16D to positionally rotationally adjust to the height of the feed material, rising or lowering in an attempt to maintain a near-continuous pressure on the feed material.

Moreover, the known power-feed wheels 16D may be pivotally mounted on at least one arm 50 with a single rotational pivot point 52 that allows raising or lowering of the power feed wheel 16D in response to the feed material. Typical power feed wheels 16D include a single pair of arms 50, pivotally mounted on a single axis. Typically, the power feed wheel 16D is rotationally mounted to the arms 50 opposite the rotational axis 52, as shown in FIG. 3.

This known arrangement results in the power feed wheel 16D moving in a radial pathway R that is not concentric with the rotor's circumference. R represents the radial pathway taken by the power feed shaft 16S in a lowered position to a raised position, illustrated as 16S′. Known single-pivot rotational power feed wheels 16D include a power feed wheel arm 50 radius that is generally greater than the radial pathway circumscribed by the rotating fragmenting rotor teeth within the fragmenting chamber 14.

Moreover, the rotational axis 52 for the single-pivot point arm(s) 50 is generally higher than the rotor axis, which means that the power feed wheel 16F necessarily pivots outwardly away from the rotor as it rises. The result is that the power feed wheel 16F necessarily, and undesirably, moves outwardly and upwardly away from the fragmenting rotor along dashed radial pathway R. Thus, the power feed wheel 16D moves laterally and vertically away from the fragmenting rotor 42. As the lateral and/or vertical distance between the fragmenting rotor 42 and the power feed wheel 16D increase, the power feed wheel 16D loses desired control over the feed material and fragmenting efficacy diminishes. The problem related to increasing vertical distance between the fragmenting rotor 42 and power feed wheel 16D in known machines is directly related to the height of the feed material.

Use of an auxiliary powerfeed helps overcome these problems.

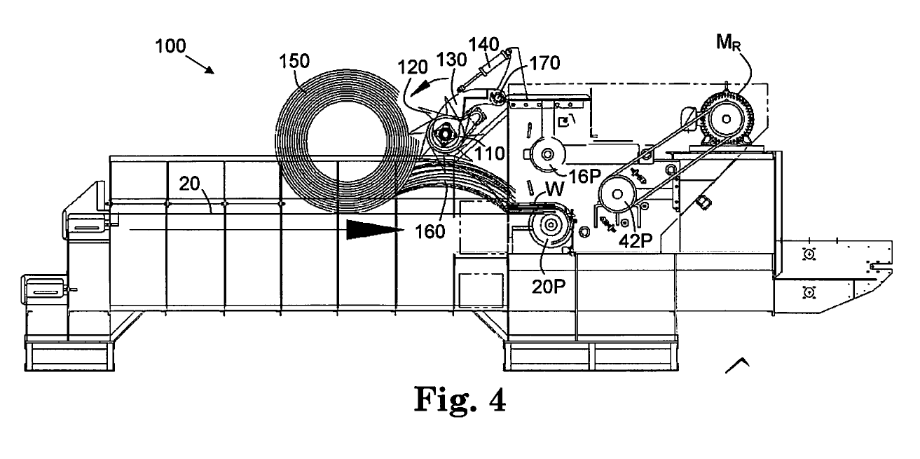

FIGS. 4-7 are cross-sectional drawings of a waste fragmenting machine 100, or horizontal grinder 100, which uses an auxiliary powerfeed to break apart incoming round agricultural bales before they reach the standard powerfeed. As noted above, although the auxiliary powerfeed is shown in the figures as working with round bales, it may also be used with square bales, baled recyclables (such as plastic bottles), gaylord boxes, cabinets, crates, and other suitable objects.

The fragmenting machine 100 of FIGS. 4-7 includes many elements that are similar or identical in function to those shown in FIGS. 1-3. For clarity, only a portion of these common elements are shown in FIG. 4. The common elements that are shown are labeled with the same two-digit element numbers as the corresponding elements in FIGS. 1-3. These common elements, and those that are present in machine 100 but are not shown in FIGS. 4-7, are described below.

Bales 150 are fed from above onto a horizontally-moving conveyor 20. The conveyor is driven by a pulley 20P, and its motion is shown by the large arrow in FIG. 4 that points to the right. The bales 150 on the conveyor 20 encounter an auxiliary powerfeed (element numbers 110-140 and 170) that breaks them into smaller pieces 160 to form waste material W.

Note that the auxiliary powerfeed is not present in the known designs of FIGS. 1-3; an exemplary design for an auxiliary powerfeed is described in detail below, following this general description of the fragmenting machine 100. In the known designs of FIG. 1-3, the waste material W may be the bales themselves; in the design of FIGS. 4-7, the waste material W may be the smaller pieces 160 from the auxiliary powerfeed.

The waste material W encounters a powerfeed system 16 (see FIG. 2) that distributes it generally uniformly laterally across the width of the conveyor 20 (i.e., in the direction into the page in FIGS. 4-7) and regulates its flow longitudinally (i.e., along the travel direction of the conveyor 20). Essentially, the powerfeed system 16 may include a toothed wheel 16D (see FIG. 2) that turns in concert with the conveyor motion, and allows flow of only enough material that fits among its teeth to pass along the conveyor. In general, the output from the powerfeed system 16 has a more uniform flow than its input, which is desirable. In FIG. 4, only the drive sprocket 16P for the powerfeed system 16 is shown; its center of rotation is coincident with the center of rotation of the toothed wheel 16D.

The output from the powerfeed system 16, which is roughly uniform in flow rate and lateral distribution across the conveyor 20, is fed to a fragmenting rotor 40 within a fragmenting chamber 14 or grinding chamber 14 (see FIG. 2). The rotor 40 has a center of rotation coincident with a power shaft pulley 42P, and is driven by a belt that connects it to a rotary motor M_{R}. The grinding chamber 14 includes a screen 44 (see FIG. 2) having particularly sized holes, so that once the material is broken down to a particular size, it passes through the screen 44 and exits the grinding chamber 14.

The output from the grinding chamber 14, known as processed products D, is carried by an output conveyor 52 out of the fragmenting machine 100.

The auxiliary powerfeed (element numbers 110-140 and 170 in FIGS. 4-7) is presently described in detail.

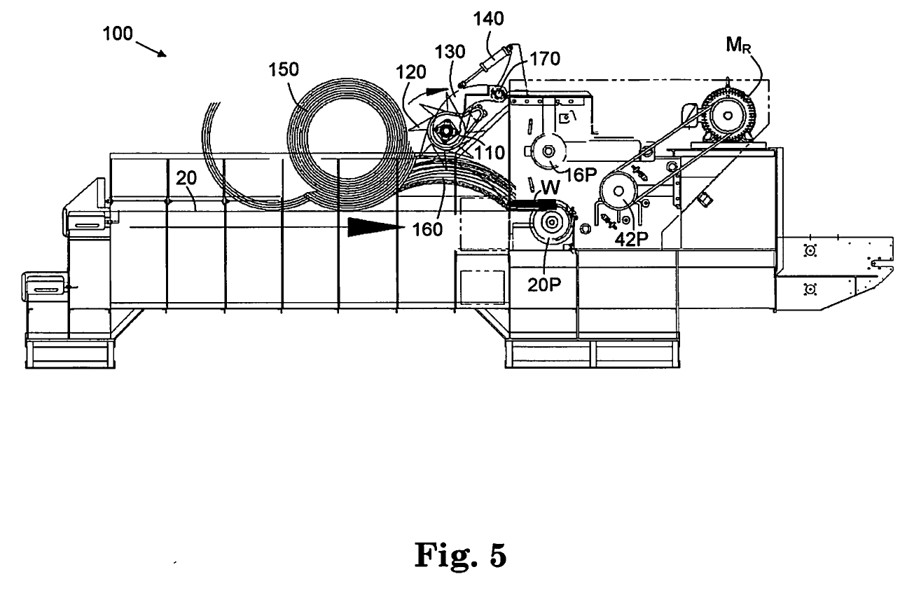

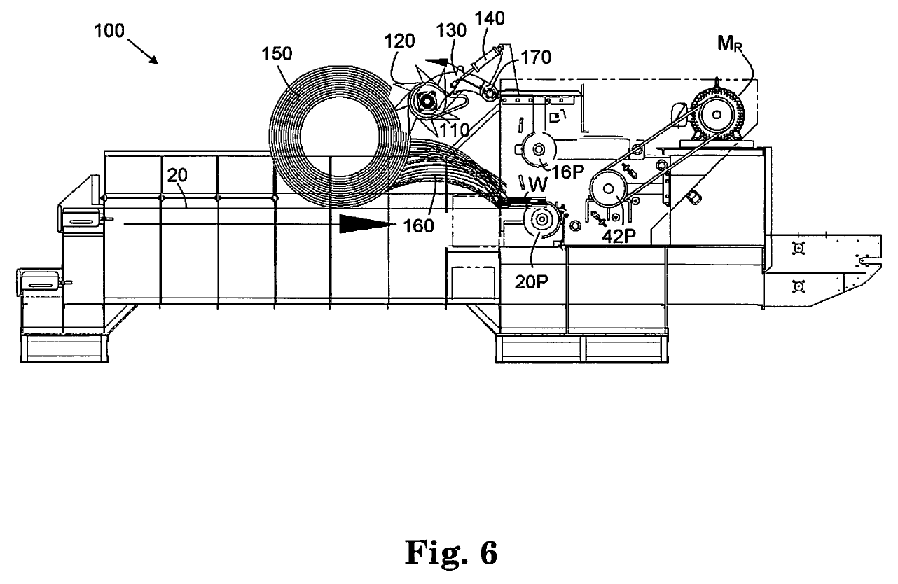

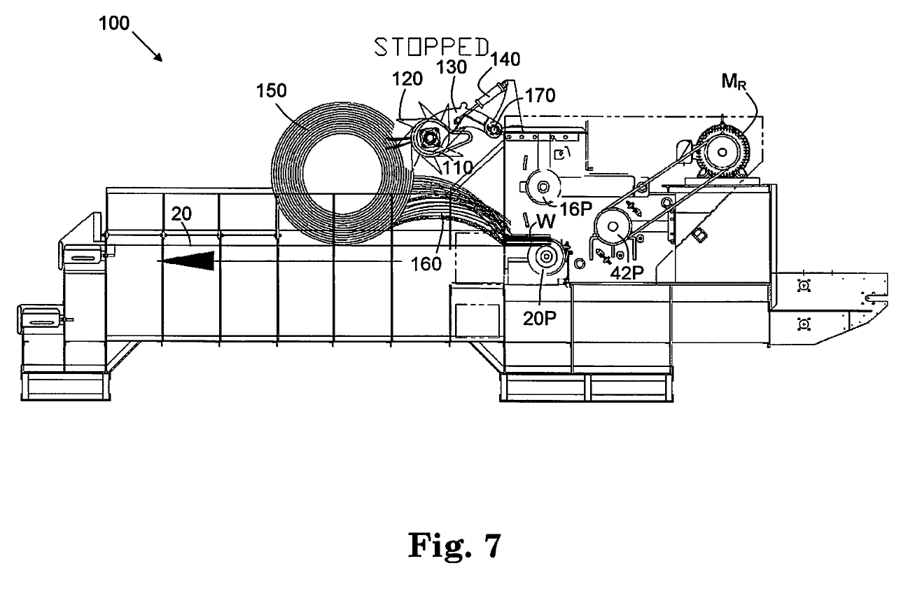

The auxiliary powerfeed features a rotating drum 110 that rotates along an axis generally parallel to the ground and perpendicular to the direction of travel of the conveyor 20. In the design of FIGS. 4-7, the rotational axis of the drum 110 is into the page. The drum rotation is controllable by the fragmenting machine 100. Specifically, the drum is rotatable in a “forward” direction, in which the bottom of the drum (the side facing the conveyor 20) travels parallel to the conveyor 20, and in a “reverse” direction, in which the bottom of the drum travels in the opposite direction as the conveyor 20. The rotation direction in FIGS. 4 and 6, shown in the drawing by a counterclockwise directional arrow, is the “forward” direction. The rotation direction in FIG. 5, shown in the drawing by a clockwise directional arrow, is the “reverse” direction. The drum is stopped, or rotationally stationary, in FIG. 7.

The rotating drum 110 includes a series of rigid tines 120 or teeth 120 mounted on its exterior. The teeth 120 have profiles that perform different functions when the drum is rotated in forward and reverse directions. When the drum is rotated in the forward direction, the side of each tooth 120 that contacts the bales is set at such an angle as to penetrate the bale. When the drum is rotated in the reverse direction, the side of each tooth 120 that contacts the bale is set at such an angle as to push the object backwards, away from the auxiliary powerfeed, rather than digging into the object.

In some cases, the teeth 120 are formed in a series of parallel planes, with each plane being perpendicular to the rotational axis of the drum (and being parallel to the page of FIGS. 4-7). In these cases, the teeth may be formed on a replaceable wheel, similar to the blades of a circular saw. Such a configuration may be beneficial for manufacturing, and for replacement of damaged teeth. The series of planes that subtend the full lateral extent of the conveyor may include two, three, four, five, six, seven, eight, nine, ten, or more than ten planes.

The teeth 120 are mounted around the rotational axis of the drum 110, for each plane of teeth. Each plane may include two, three, four, five, six, seven, eight, nine, ten or more than ten teeth. In most cases, for each plane of teeth, the teeth are equally spaced apart around the rotational axis of the drum 110. In some cases, one or more of the teeth may be irregularly spaced.

In some cases, for two or more adjacent planes of teeth 120, the rotational locations of the teeth 120 are staggered, so that two teeth 120 do not lie directly laterally adjacent to each other. In other cases, for two or more adjacent planes of teeth 120, the teeth 120 line up rotationally.

In some cases, there is some space between the adjacent planes of teeth 120. In other cases, the teeth 120 of one plane fully extend to the teeth 120 of the adjacent plane.

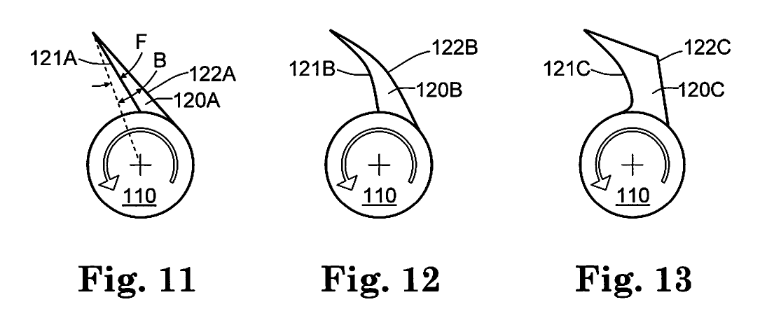

Various geometries of the teeth are described in FIGS. 11-13 and the text that follows.

FIG. 11 is a cross-sectional drawing of a drum 110, showing only one tooth 120A. For this design, the front 121A and back 122A faces of the tooth 120A are both planar. With respect to a line connecting the center of rotation of the drum 110 to the point of the tooth (the dotted line in FIG. 11), angles of inclination are defined for the front (F) and back (B) surfaces of the tooth. In this case, both angles F and B are greater than zero, since the front 121A and back 122A faces both lie on the right side of the dotted line. Such a geometry allows for “cutting” when the drum 110 is rotated in the forward direction (counter-clockwise in FIG. 11), and allows for “pushing” when the drum 110 is rotated in the reverse direction (clockwise in FIG. 11).

Some acceptable ranges for the front inclination angle F include: 0 to 60 degrees, 0 to 50 degrees, 0 to 40 degrees, 0 to 30 degrees, 0 to 20 degrees, 0 to 10 degrees, 5 to 60 degrees, 5 to 50 degrees, 5 to 40 degrees, 5 to 30 degrees, 5 to 20 degrees, 5 to 10 degrees, 10 to 60 degrees, 10 to 50 degrees, 10 to 40 degrees, 10 to 30 degrees, and 10 to 20 degrees.

Some acceptable ranges for the back inclination angle B include: 20 to 80 degrees, 20 to 70 degrees, 20 to 60 degrees, 20 to 50 degrees, 20 to 40 degrees, 20 to 30 degrees, 30 to 80 degrees, 30 to 70 degrees, 30 to 60 degrees, 30 to 50 degrees, 30 to 40 degrees, 40 to 80 degrees, 40 to 70 degrees, 40 to 60 degrees, and 40 to 50 degrees.

In contrast with the planar tooth 120A of FIG. 11, FIG. 12 shows a tooth 120B having curved front 121B and back 122B sides. In this design, the front surface 121B is concave, and the back surface 122B is convex. Alternatively, both surfaces may be planar, or one surface can be planar, while the other surface is curved.

The angles of inclination of the front 121B and back 122B surfaces of the tooth 120B may be defined similar to what is shown in FIG. 11, if the angles are defined using the local slopes (or local surface tangents) at the point of the tooth. The acceptable ranges for the front and back inclination angles are the same as those described above for the planar geometry of FIG. 11.

In FIG. 13, the tooth 120C includes a front surface 121C that is curved at the point at which it meets the rest of the drum 110. Such a feature may be helpful in expelling material from the drum as it rotates, so that material is prevented from getting stuck in a concave corner. This curved feature may also be used on the rear surface. In addition, the rear surface 122C includes a convex corner. Alternatively, the front surface may also include a convex or concave corner. As a further alternative, either surface may include more than one corner.

The drum 110 itself is mounted on an adjustable arm 130, which can exert a controllable force downward toward the conveyor 20 and/or can move to a controllable height above the conveyor 20. The adjustable arm 130 may be referred to as a lift arm 130.

The lift arm 130 holds the axial shaft of the drum 110 at each lateral end. A set of hydraulic cylinders 140 is mounted to the lift arm 130, one on each end of the drum 110.

In some cases, such as the specific designs shown in FIGS. 4-7, the arm itself 130 is anchored to the frame of the machine by a hinge 170 at the end opposite the drum 110, and the hydraulic cylinders 140 are attached to the arm 130 a distance away from the hinge 170. In these cases, the hydraulic cylinders provide a torque about the hinge 170 for the arm 130, which can translate upward or downward the drum-holding end of the arm 130. The downward pressure allows the teeth 120 of the auxiliary powerfeed to penetrate the feed object (such as the bale 150) and tear parts from the whole.

In other cases, the arm itself may be longitudinally translatable, rather than pivotable about a hinge. In those cases, the hydraulic cylinders may directly provide the downward force, rather than providing a torque about a hinge.

Pressure from the drive motor hydraulic pressure is monitored by a pressure transducer or other appropriate device. In some cases, if the pressure exceeds a set limit, the auxiliary powerfeed reverses direction. This reversing of rotation direction is beneficial for a number of reasons, as described below in the context of various examples.

The default operating condition has the conveyor 20 progressing in the forward direction (feeding material into the machine 100), and the drum 110 rotating in the forward direction (the side of the drum 110 facing the conveyor 20 moving in the same direction as the conveyor 20). Both of these directions are shown by arrows in FIG. 4.

During operation, bales 150 or other objects are fed along the conveyor 20 and encounter the teeth 120 in the rotating drum 110. The forward rotation of the teeth 120 causes the drum 110 to “climb up” the near side of the bale 150 (as in FIG. 6). In most cases, the “climbing” is tolerated by the machine 100, and the drum 110 is allowed to rise and fall as needed during operation of the machine 100. In other cases, the drum 110 is held at a fixed height by the arm 130, and is prevented from “climbing” by a strong force from the hydraulic cylinders 140. For the discussion below, it is assumed that such “climbing” of the bale 150 is tolerated by the machine 100.

The auxiliary powerfeed rotates the drum 110 in the forward direction until the drive motor hydraulic pressure exceeds a certain limit, which occurs when the teeth 120 become stuck in a bale 150 or other object and the drum 110 stops or has difficulty rotating. When the pressure reaches the set limit, the auxiliary powerfeed reverses the rotation direction of the drum 110.

As the teeth 120 contact the oncoming feed object 150, the rotation of the drum causes the drum to rise upward, climbing up the feed object 150 (as in FIG. 6). The hydraulic cylinders 140 apply downward pressure, forcing the teeth 120 into the object 150. At this stage, the teeth 120 rotate down into the object 150. The drum rotation will produce different effects on the feed object 150, depending on the object's construction, consistency, and the form in which the object 150 arrives at the auxiliary powerfeed. Various specific types of objects 150 are considered below.

First, we discuss a square bale. When a properly-loaded square bale reaches the auxiliary powerfeed, the rotation of the drum 110 will typically break the bale into the rectangular segments formed during its construction. Once the binding of a square bale is broken or removed, these segments typically break apart from each other fairly easily. Since square bales break apart easily, the auxiliary powerfeed most likely will not stall and will continue rotating in forward direction.

Next, we discuss a round agricultural bale. If a round bale of relatively loose, uncompressed material reaches the auxiliary powerfeed, the rotation may freely separate loose material from the bale into a smooth flow to the rotor, without stalling the drive motors or creating an overpressure situation.

Next, if a bale of dense, wet material reaches the auxiliary powerfeed, the drum rotation will likely stall after the teeth 120 have torn away only a small portion of the bale. When the drum rotation stalls, it reverses for a set time, then resumes forward rotation. The infeed conveyor 20, however, continues in its forward motion. The bale is thus pushed in opposing directions, causing the bale to roll. For the configuration in FIG. 4, with the conveyor 20 moving to the right, and the reverse direction of the drum 110 being clockwise, the bale 150 is rolled counter-clockwise.

In general, the bale may roll away from the auxiliary powerfeed, or it may remain in more or less constant contact with the auxiliary powerfeed as it continues to roll. If the bale is placed in the infeed conveyor hopper in an optimal way (according to the way the bale is rolled during its formation), this backward rolling may cause the bale to unroll, with the unrolled portion being carried toward the rotor. The portion torn from the bale during the auxiliary powerfeed's forward rotation allows the bale to unroll. Even if the bale is placed into the infeed so this backward rolling motion does not cause it to unroll smoothly and continuously, this backward rolling motion typically causes some portion of the bale to fall away.

Next, we consider a case where the auxiliary powerfeed may not tear any material away from the bale during its first forward-stop-reverse cycle. After reversing for a set time, the auxiliary powerfeed may resume forward rotation. If the rotation stalls again, the auxiliary powerfeed will reverse again.

In general, the control system is designed to repeat the forward-stop-reverse cycle a set number of times. For a typical round bale application, the control system may be set to repeat the forward-stop-reverse cycle three times. A different number of repetitions may be appropriate for certain applications, including two, four, five, six, seven, eight, or more than eight repetitions.

After repeating the stop-reverse-forward cycle a set number of times, the control system may reverse the auxiliary powerfeed's rotational direction for an extended interval, while the infeed conveyor 20 and regular powerfeed continue in forward motion. Doing so may allow a round bale 150 to continue to unroll.

If needed, the auxiliary powerfeed rotation may be stopped, and the conveyor 20 may be run in reverse, as is shown in FIG. 7. This may optionally be implemented by the control system of the fragmentation machine 100, in order to allow the difficult bale 150 or other object to be manually adjusted or removed from the machine.

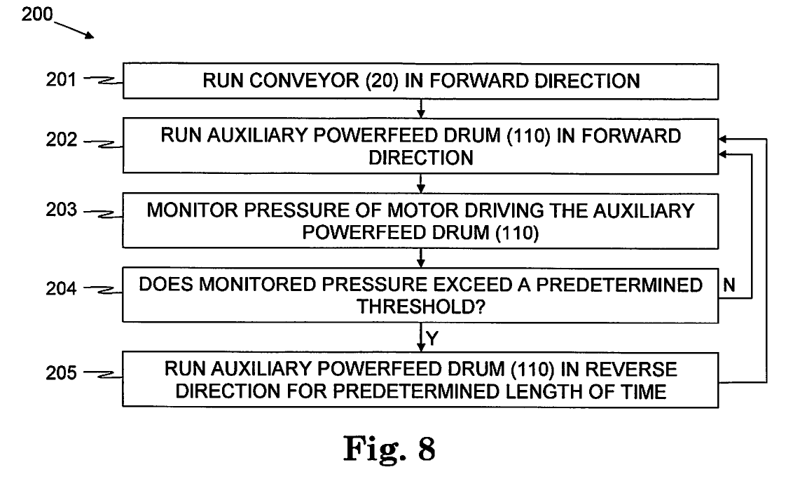

FIGS. 8-10 are flow charts showing various aspects of the control system for the auxiliary powerfeed system.

FIG. 8 has a flow chart 200 showing how the system detects an object on the conveyor that is too large, dense, or hard to pass through to the regular powerfeed. Such an object may be considered a non-cuttable resistance, and may be referred to in this document as a “blocking resistance”. Upon encountering such a blocking resistance, the teeth 120 on the drum 110 may get stuck in, rather than cut through, the material, and the forward rotation of the drum may force the drum to “walk up” a side of the material and raise the drum.

In step 201, the conveyor 20 is run in the forward direction. In step 202, the drum 110 of the auxiliary powerfeed is run in the forward direction. In step 203, the pressure is read from the motor that drives the drum 110; such a pressure is easily read from a hydraulic motor. Note that if other types of motors are used, there are analogous quantities that may be measured, such as current, velocity, acceleration, and so forth. In step 204, the measured value (pressure, current, etc.) is compared to a predetermined threshold value (threshold pressure, threshold current, etc.). If the measured value is below the threshold value, the system is functioning properly, and the process is returned to step 202. If the measured value is above the threshold, the system detects that the bale 150 needs additional processing before passing to the regular powerfeed. In step 205, the drum 110 rotation is reversed for a particular length of time, so that the bale 150 is pushed backwards and/or rolled along the moving conveyor 20. After the particular time interval, the system returns to step 202.

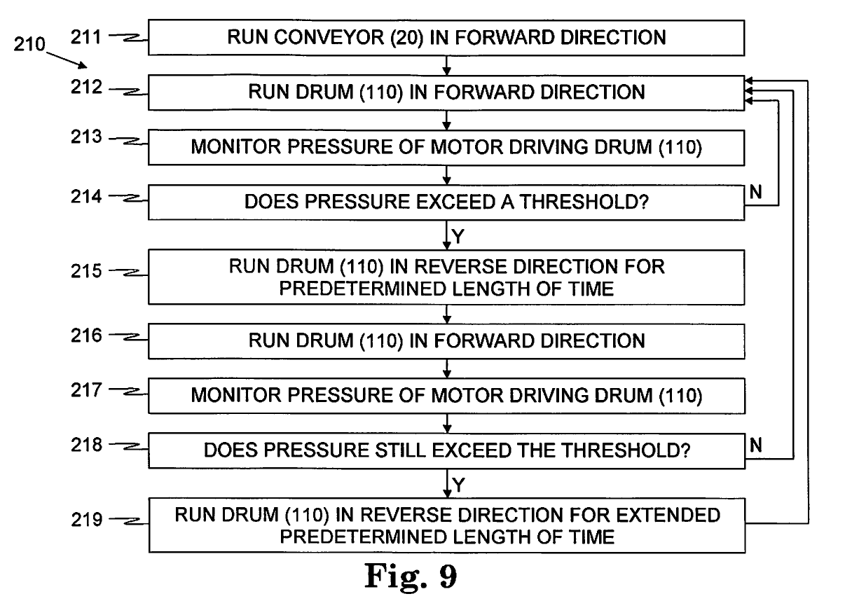

FIG. 9 has a flow chart 210 showing that for a particularly troublesome bale, where a short reverse run of the drum is inadequate, the drum may be run in reverse for an extended time interval.

The conveyor 20 is run in the forward direction (step 211). The drum 110 is run in the forward direction (step 212). The motor pressure is read (step 213, much like step 203 in FIG. 8). If the measured pressure is less than a threshold value (step 214), the bale 150 needs no further processing and the system returns to step 212. If the measured pressure exceeds the threshold value, the bale 150 needs additional processing. The drum 110 direction is reversed for a particular time interval (step 215), which is relatively short (much like step 205). The drum is then run in the forward direction again (step 216), and the drum motor pressure is read (step 217) and compared with the threshold (step 218). If the measured pressure still exceeds the threshold pressure, then the drum direction is reversed and is run in the reverse direction for an extended period of time (step 219), which is longer than the relatively short time interval of step 215.

The terms “relatively short” and “relatively long” are further clarified below.

For a “relatively short” time interval, the auxiliary powerfeed pushes or rolls the bale back along the conveyor long enough to reorient it. Once the short time interval has passed, the drum rotates again in the forward direction, and the teeth contact the bale at a different location on the bale. Preferably, cutting or clawing at the different location on the bale allows the bale to be effectively broken up by the auxiliary powerfeed. In practice, the length of a “relatively short” time interval depends on the speed of the conveyor and the size of the bales, but reasonable relatively short time intervals may be in the range of 1-60 seconds, 2-30 seconds, 5-15 seconds, and 10-14 seconds. Appropriate intervals depend on bale consistency and other factors identified above, and the intent is not to limit the scope of the present invention based on these example intervals.

For a “relatively long” time interval, it is expected that the operator of the grinder will have enough time to manually reorient or reposition the bale on the conveyor, if necessary. In practice, the length of a “relatively long” time interval will also depend on the speed of the conveyor and the size of the bales, but reasonable relatively long time intervals may be in the range of 45-90 seconds, 60-75 seconds and 65-70 seconds, depending on bale construction, bale density, and other factors that affect the ease at which a bale may be separated into a loose flow of material. In some cases, intervals greater or less than the examples provided may be appropriate.

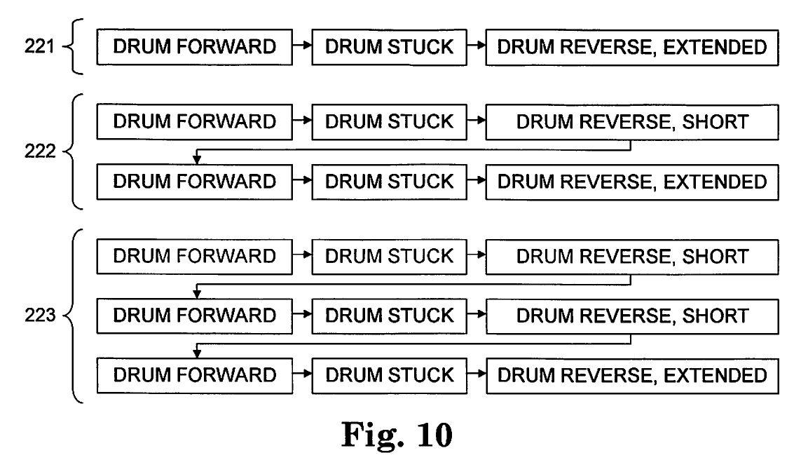

FIG. 10 has various flow charts that show when to employ an extended reverse run of the drum.

In chart 221, if the drum is run in the forward direction (much like steps 201 and 202 in FIG. 8) and gets stuck (much like step 203 and the “Y” choice from step 204), then the drum direction is reversed and is run in reverse for an extended period of time.

In chart 222, once the drum gets stuck, the system first employs a relatively short period of running in reverse (much like step 215). If the drum is still stuck after a short reverse time interval, then the system runs in reverse for the extended period of time.

In chart 223, the system tries twice with short reverse runs before using the extended reverse run.

It will be appreciated that any number of relatively short reverse runs may be used before the extended reverse run, including zero (chart 221), one (chart 222), two (chart 223), three (not shown in FIG. 10), four, five, or more than five.

Finally, we note several interesting features of the auxiliary powerfeed and its associated control system, which are absent from any previously known fragmentation machines.

First, the auxiliary powerfeed has the ability to reverse direction while the infeed conveyor and regular powerfeed continue in forward motion, allowing a round bale to unroll. The initial forward motion allows its teeth to tear a divot from the bale, which allows the bale to unroll as it rolls backward. Other known bale breakers may be designed simply to tear away material, not unroll a bale.

Second, the auxiliary powerfeed reverses direction according to hydraulic pressure. This means that for any object that comes apart easily, the auxiliary powerfeed will continue rotating in forward motion, effectively separating material from the whole. This feature allows the auxiliary powerfeed to automatically function differently for different feedstocks.

Third, the teeth are angled so that they penetrate and tear when the drum is rotated in the forward direction, and so that they push material away when the drum is rotated in the reverse direction.

Fourth, there are several settings that can be adjusted to suit different feedstocks. For instance, one may adjust the hydraulic pressure at which the auxiliary powerfeed reverses, the duration or reverse rotation, the number of times it goes through a forward-reverse-forward cycle before staying in reverse for an extended period, and/or the time for which it stays in extended reverse rotation.

By adjusting any or all of these settings, an operator can match a number of different factors, listed below.

A first factor is the type of binding used and the difficulty of separation of the material.

A second factor is the different levels of construction. For instance, the core of a bale will not unroll like the outer portions. Forward rotation will be more effective when a bale is reduced to its core. Operators can fine tune all settings so that the auxiliary powerfeed resumes forward motion at the average time required to reach the core.

A third factor is the geometry of construction. For instance, a rectangular cabinet will not unroll like a bale. An extended reverse interval would be inappropriate. A short reverse time may help the auxiliary powerfeed achieve a different angle of approach and different surface to contact.

In general, the ability to adjust all settings, and having control over settings in a centralized control system, is quite desirable.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

We claim:

1. An auxiliary powerfeed attachable to a frame of a fragmentation machine, comprising:
a pivotable arm attached to the frame at a hinge;
a rotatable drum disposed at an end of the pivotable arm away from the hinge, the drum being rotatable in a forward direction complementary to a direction of a generally horizontal conveyor that feeds material into the fragmentation machine, the drum also being rotatable in a reverse direction opposing the direction of the conveyor; and
a plurality of angled teeth on the drum, the teeth being configured to cut the material when the drum is rotated in the forward direction and configured to push the material when the drum is rotated in the reverse direction.

2. The auxiliary powerfeed of claim 1, further comprising a hydraulic cylinder attached at a first end to the frame of the fragmentation machine and attached at a second end opposite the first end to the pivotable arm between the hinge and the rotatable drum.

3. The auxiliary powerfeed of claim 2, wherein the hydraulic cylinder exerts a force on the pivotable arm that drives the rotatable drum generally downward toward the conveyor.

4. The auxiliary powerfeed of claim 3, wherein when the teeth on the drum encounter a blocking resistance in the material, rotation of the drum forces the teeth to walk up a side of the material and drives the drum generally upward away from the conveyor.

5. The auxiliary powerfeed of claim 4, wherein the force exerted by the hydraulic cylinder is insufficient to overcome upward movement of the drum.

6. The auxiliary powerfeed of claim 1, further comprising a second hydraulic cylinder attached at a first end to the frame of the fragmentation machine and attached at a second end opposite the first end to the pivotable arm between the hinge and the rotatable drum, wherein the hydraulic cylinder and the second hydraulic cylinder are attached at opposite lateral ends of the pivotable arm.

7. The auxiliary powerfeed of claim 1, further comprising a control system that temporarily reverses direction of rotation of the drum when the drum encounters a blocking resistance in its forward rotation.

8. The auxiliary powerfeed of claim 1, wherein each tooth comprises a front face and a rear face, the front and rear faces having angles of inclination greater than zero.

9. A subsystem of a fragmentation machine, comprising:
a generally horizontal conveyor for feeding round bales into the fragmentation machine along a conveyor direction;
a rotatable drum disposed above the conveyor, the drum having a generally horizontal rotational axis generally perpendicular to the conveyor direction, the drum being rotatable in a forward direction complementary to the conveyor direction, the drum also being rotatable in a reverse direction opposing the conveyor direction; and
a plurality of angled teeth on the drum, the teeth being angled to tear material from the round bales when the drum is rotated in the forward direction and angled to unroll the round bales along the conveyor when the drum is rotated in the reverse direction.

10. The subsystem of claim 9, wherein the angled teeth are arranged in parallel planes, each plane being generally vertical and generally parallel to the conveyor direction.

11. The subsystem of claim 10, wherein the teeth in each plane are equally spaced around the rotational axis of the drum.

12. The subsystem of claim 10, wherein the teeth in a particular plane are rotationally spaced apart from corresponding teeth in an adjacent plane, and do not lie laterally adjacent to the corresponding teeth in the adjacent plane.

13. A method for controlling an auxiliary powerfeed for a fragmentation machine, comprising:
running a generally horizontal conveyor in a conveyor direction;
rotating with a hydraulic drum motor a drum having angled teeth in a forward direction complementary to the conveyor direction, the teeth being angled to cut material on the conveyor when the drum is rotated in the forward direction;
detecting a pressure from the hydraulic drum motor;
comparing the detected pressure with a predetermined pressure threshold;
determining that the detected pressure exceeds the predetermined pressure threshold; and
rotating with the hydraulic drum motor the drum in a reverse direction opposing the conveyor direction, the teeth being angled to push the material on the conveyor when the drum is rotated in the reverse direction.

14. The method of claim 13, further comprising maintaining the rotation of the drum in the reverse direction for a predetermined length of time.

15. The method of claim 14, wherein the predetermined length of time is relatively long.

16. The method of claim 14, wherein the predetermined length of time is relatively short.

17. The method of claim 16, further comprising, subsequent to the step of maintaining the rotation of the drum in the reverse direction for a relatively short predetermined length of time:
rotating with the hydraulic drum motor the drum in the forward direction;
detecting the pressure from the hydraulic drum motor;
comparing the detected pressure with the predetermined pressure threshold;
determining that the detected pressure exceeds the predetermined pressure threshold;
rotating with the hydraulic drum motor the drum in the reverse direction; and
maintaining the rotation of the drum in the reverse direction for a relatively long predetermined length of time.

18. The method of claim 16, further comprising, subsequent to the step of maintaining the rotation of the drum in the reverse direction for a relatively short predetermined length of time:
rotating with the hydraulic drum motor the drum in the forward direction;
detecting the pressure from the hydraulic drum motor;
comparing the detected pressure with the predetermined pressure threshold;
determining that the detected pressure exceeds the predetermined pressure threshold;
rotating with the hydraulic drum motor the drum in the reverse direction;
maintaining the rotation of the drum in the reverse direction for a relatively short predetermined length of time.
rotating with the hydraulic drum motor the drum in the forward direction;
detecting the pressure from the hydraulic drum motor;
comparing the detected pressure with the predetermined pressure threshold;
determining that the detected pressure exceeds the predetermined pressure threshold;
rotating with the hydraulic drum motor the drum in the reverse direction; and
maintaining the rotation of the drum in the reverse direction for a relatively long predetermined length of time.
